(19) United States
(12) Patent Application Publication
(10) Pub. No.: US 2025/0003266 A1
(43) Pub. Date: Jan. 2, 2025

(54) RECREATIONAL VEHICLE DOOR HANDLE ASSEMBLY

(71) Applicant: RVLock & Co, LLC, Wellsville, UT (US)

(72) Inventor: G. Cade Harris, Wellsville, UT (US)

(21) Appl. No.: 18/345,995

(22) Filed: Jun. 30, 2023

(51) Int. Cl. E05B 85/16

(52) U.S. Cl. CPC E05B 85/16; E05B 83/44

(57) ABSTRACT

A door handle assembly is provided that comprises a handle with a rigid section and an actuatable section. When the door handle assembly is in a latched position (e.g., when a latch is extended), the rigid section and the actuatable section may share a substantially similar surface profile. The rigid section and the actuatable section may also be substantially adjacent to each other as to allow users to operate a door more easily with a single hand.

### BACKGROUND

A door handle provides a way for users to open and close doors, which is typically achieved by operating a latch that interfaces with the door handle's internal mechanisms. Door handles have also been used to allow access to recreation vehicles (RVs). Many door handles of RVs utilize a paddle handle design, where a user-operable paddle is rotatable about an axis to facilitate actuation of a door latch to enable opening and closing of the door. The paddle handle, when in the latched position (or rest position), maintains the door latch in an extended position. When a user rotates the paddle handle into an unlatched position, the door latch retracts so that the door may be freely opened or closed.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

Reference will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

FIG. 1 illustrates a front perspective view of an example door handle assembly in a latched configuration.

FIG. 2 illustrates a front perspective view of the example door handle assembly in an unlatched configuration.

FIG. 3 illustrates another perspective view of the example door handle assembly in the latched configuration.

FIG. 4 illustrates a front facing view of the example door handle assembly in the latched configuration.

FIG. 5 illustrates a side view of the example door handle assembly in the latched configuration.

FIG. 6 illustrates a rear facing view of the example door handle assembly in the latched configuration.

FIG. 7 illustrates a top view of interior and exterior components of a door handle assembly in a latched configuration.

FIG. 8 illustrates a top view of interior and exterior components of a door handle assembly in an unlatched configuration.

### DETAILED DESCRIPTION

Implementations of the present disclosure extend to door handle assemblies, such as recreational vehicle door handle assemblies.

Existing interior RV door handles allow for users to open and close RV doors. As noted above, many RV door handles implement a paddle handle for operation by users. However, existing RV door handles have numerous deficiencies. For example, to allow for exiting of an RV, many existing interior paddle handles require a user to rotate the paddle handle toward the user to unlatch the door while simultaneously pushing the door away from the user. Because the entire paddle that the user grips is typically rotatable, users often resort to pushing on a different portion of the RV door to push the door into an open position (while maintaining the rotational force on the paddle handle). For instance, to open a conventional RV door, users often resort to contorting their hands into awkward and/or strenuous configurations to facilitate rotation of the paddle handle with their fingers (to unlatch the door) while simultaneously pushing on the handle housing with other parts of the hand or wrist (to push the door into an open position). As another example, some users resort to exerting their body weight on the door while operating the door paddle handle to push the door open. Such modes of operation can present a multitude of safety hazards that could result in injury and/or discomfort to users.

Another challenge associated with conventional RV door paddle handles is that such paddle handles are usually configured to be operated by user digits (fingers) from a certain direction. For instance, many existing RV door handle assemblies often comprise a finger opening that faces leftward (relative to a user facing the interior of the RV door), making such RV door handle assemblies more convenient for left-handed operation. Thus, righthanded users often encounter inconvenience and/or difficulty when attempting to operate many conventional RV door handle assemblies.

At least some disclosed embodiments may be implemented to overcome at least some of the above-mentioned deficiencies of existing door handle assemblies by providing users with a door handle assembly that includes a handle with an actuatable section and a rigid section. The rigid section maintains a fixed position during operation of the door handle assembly, while the actuatable section is configured to actuate between latched and unlatched positions during operation of the door handle assembly.

The actuatable section (when in the unlatched position) may be positioned adjacent to the rigid section and/or may follow the surface profile of the rigid section. In some instances, the actuatable section and the rigid section define different regions of a continuous gripping space between the handle and a housing to which the handle is attached. Such features can allow users to easily manipulate both the actuatable section (to cause the door latch to retract) and the rigid section (to push or pull the door) with a single hand. For instance, a user may utilize their thumb and index finger to grip the rigid section while rotating the actuatable section with one or more other fingers. Such a hand configuration for operating a door handle assembly of the present disclosure may be more convenient and/or comfortable for users (e.g., relative to hand configurations employed to operate conventional paddle handles for RV doors).

In some instances, an actuatable section and a housing of a door handle assembly form an opening for receiving a user's fingers to enable actuation of the actuatable section. The actuatable section may be configured to rotate about a pivot that is offset from the actuatable section in the direction of the opening defined by the actuatable section and the housing. Such a configuration can allow the door handle assembly to receive user digits from the right, thereby facilitating convenient right-handed operation (e.g., when implemented on RV doors).

It should be understood that although some of the disclosed embodiments describe a door handle assembly related to use in an RV, one of ordinary skill in the art could apply these methods and systems to any door assembly configured to open and/or close a door or door-like device. Additionally, it should be understood that although the term “door handle assembly” is used, this designation is not limiting of the principles disclosed herein. Alternative configurations, such as, for example, a doorknob assembly or other assemblies related to opening/closing of doors, are also contemplated by the present disclosure. One will appreciate that the directional and/or relative designations used herein (e.g., “front,” “back,” “right,” “left,” “top,” “bottom,” and the like) are utilized by way of illustrative example and for ease of description. The relative designations used herein may be replaced with others for different implementation contexts.

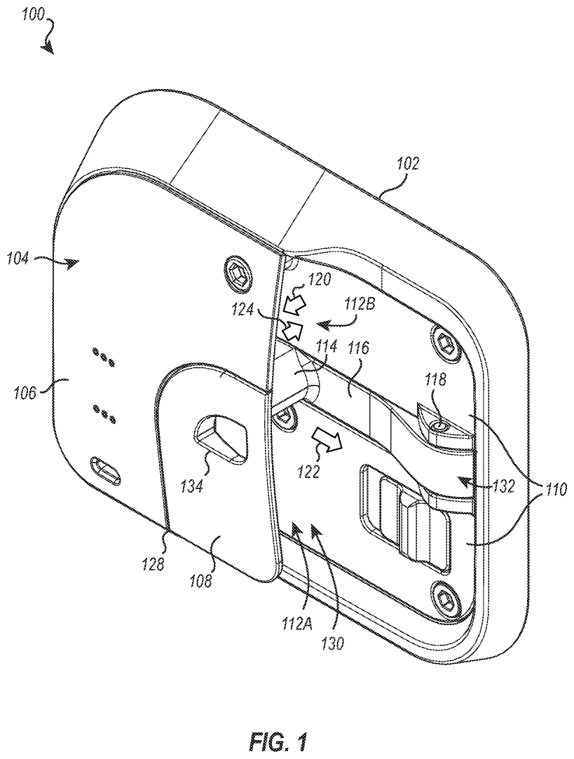

Attention will now be directed to FIGS. 1 through 8, which provide various supporting illustrations related to the disclosed embodiments.

FIG. 1 illustrates a front perspective view of an example door handle assembly 100 in a latched configuration. The door handle assembly 100 of FIG. 1 comprises a housing 102 that physically encompasses or supports the other elements of the door handle assembly 100. For instance, the housing 102 may provide a secure connection point or seal with a door (not shown). FIG. 1 illustrates that the door handle assembly 100 may further comprise a handle 104 that may be connected to the housing 102.

In the example of FIG. 1, the handle 104 comprises two sections: the rigid section 106 and the actuatable section 108. The rigid section 106 is configured to maintain a fixed position relative to the housing 102 during operation of the door handle assembly 100. In some embodiments, the rigid section 106 omits actuatable components that would allow for movement of the rigid section relative to the housing 102. As noted above, the rigid section 106 may provide a gripping location to enable users to manipulate the positioning of the door (not shown) to which the door handle assembly 100 is attached.

As shown in FIG. 1, the rigid section 106 and/or the actuatable section 108 may be offset in a first direction 120 from one or more housing plates 110 of the housing 102 of the door handle assembly 100. This offset allows for user digits (not shown) to be inserted into a gripping space 112 that is defined between the handle 104 and the housing plate(s) 110. The gipping space 112 may be defined by the housing plate(s) 110 and at least one of the rigid section 106 and/or the actuatable section 108. In the example of FIG. 1, the gripping space 112 comprises a continuous or contiguous gripping space formed between the housing plate(s) 110 and the rigid section 106 and the actuatable section 108 of the handle 104 (which are arranged flush with one another in the latched configuration shown in FIG. 1). The gripping space 112 may take on any suitable shape and/or size.

It should be understood that, in some embodiments, the housing plate(s) 110 may comprise multiple separate sections (e.g., multiple housing plates). In such instances, multiple housing plates may define the gripping space 112 instead of a single housing plate. Further, it should be understood that the gripping space 112 may comprise multiple gripping spaces. For example, rigid section 106 and the housing plate 110 may define a first gripping space 112A (or a first gripping space region) and the actuatable section 108 and the housing plate 110 may define a second gripping space 112B (or a second gripping space region). Multiple gripping spaces may be contiguous or may be separated by other components of the door handle assembly 100.

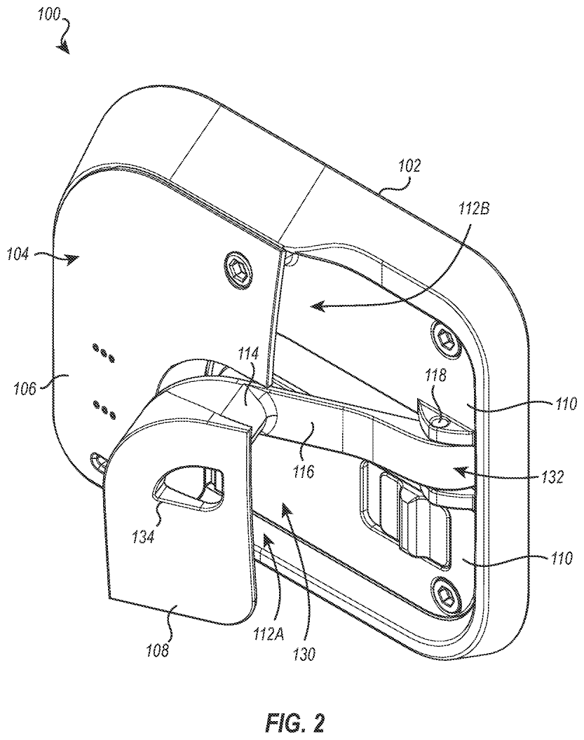

The actuatable section 108 of the door handle assembly 100 may be configured for actuation between a latched position (see FIG. 1) and unlatched position (see FIG. 2). In other words, the actuatable section 108 can be configured to actuate (move) relative to the housing 102. The latched position may comprise a resting state assumed by the actuatable section 108 unless acted on by an outside force (e.g., a part of a user's hand). For example, when a door (not shown) to which the door handle assembly 100 is attached is closed, the actuatable section 108 may rest in the latched position.

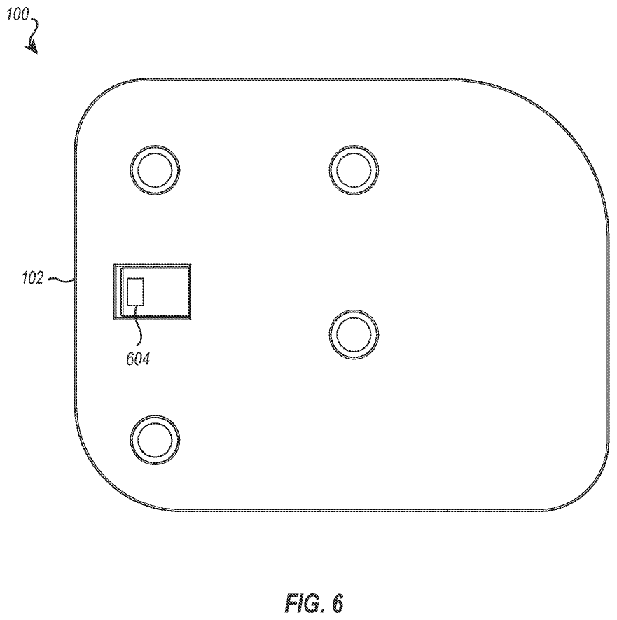

The actuatable section 108 may be operably connected to a latch 714 (see FIG. 6) that is configured to restrict the door from releasing from a catch or holder of a door frame (not shown) when the actuatable section 108 is in the latched position. When the actuatable section 108 is actuated into the unlatched position (see FIG. 2), the latch 714 may retract from engagement (or potential engagement) with the catch or holder of the door, thereby allowing the door to be freely opened (or closed).

Thus, for the purposes of at least some of the disclosed embodiments, the “latched position” may comprise a state in which the latch 714 is extended and the actuatable section 108 is flush or aligned with the rigid section 106 (see FIG. 1), and the “unlatched position” may comprise a state in which the latch 714 is retracted and the actuatable section 108 is offset from the rigid section 106 in at least the first direction 120 (see FIG. 2).

The actuatable section 108 may be arranged adjacent to the rigid section 106 when the actuatable section 108 is in the latched position. As noted above, such an arrangement may allow a user to easily manipulate both the rigid section 106 and the actuatable section 108 with a single hand. In some implementations, the shortest distance between the actuatable section 108 and the rigid section 106 (e.g., at a transition region or gap 128 between the two) is no greater than 1 centimeter (cm), though other shortest distances are within the scope of the present disclosure (e.g., 0.1 cm, 0.5 cm, 1.5 cm, 2 cm, 2.5 cm, 3 cm, or any distance greater than, less than, or between of any of the foregoing values).

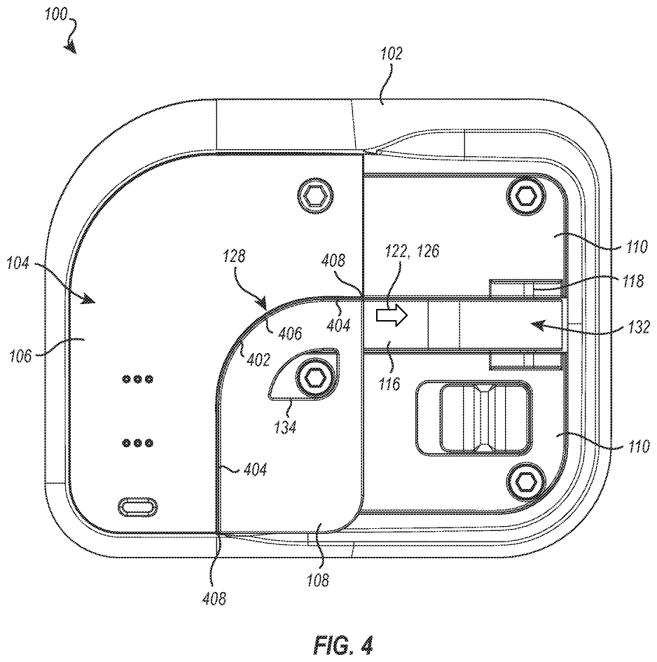

In some instances, as shown in FIG. 4, the aforementioned shortest distance between the actuatable section 108 and the rigid section 106 is arranged at least along a continuous segment of an edge 402 of the actuatable section 108. The edge 402 of the actuatable section 108 that is nearest to the rigid section 106 may be any suitable length (e.g., greater than 1 cm, less than 1 cm, or another length) and may take on any suitable shape (e.g., including at least one straight segment and at least one curved segment in some instances, as shown in FIG. 4).

It should be understood that if the actuatable section 108 is positioned too far away from the rigid section 106, then a potential user of the door handle assembly 100 may not be able to comfortably operate the actuatable section 108 and simultaneously use the rigid section 106 to push the door (not shown) open with one hand. The distance between the rigid section 106 and the actuatable section 108 at which operation of the door handle assembly 100 becomes uncomfortable for users will vary based on the user.

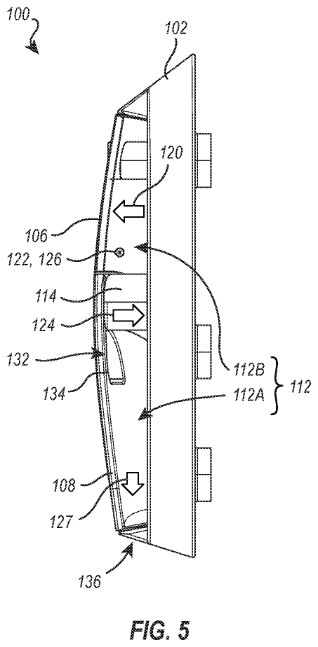

In some embodiments, the actuatable section 108 follows a surface profile of the rigid section 106 when the actuatable section 108 is in the latched position (see FIG. 5). Although the handle 104 may comprise two sections—the actuatable section 108 and the rigid section 106—the handle 104 may nevertheless seemingly appear as one continuous plate or paddle, with the rigid section 106 and the actuatable section 108 appearing to have one continuous surface profile (when the actuatable section 108 is in the latched position). For instance, when the actuatable section 108 is in the latched position, at least part of the edge(s) of the actuatable section 108 and the rigid section 106 that are nearest to one another may be aligned with one another (e.g., in at least the first direction) at a transition region between the actuatable section 108 and the rigid section 106, thereby providing a configuration where the actuatable section 108 follows the surface profile of the rigid section 106.

In some embodiments, the surface profiles of the rigid section 106 and the actuatable section 108 may be substantially planar. In other words, the surface profiles of both the rigid section 106 and the actuatable section 108 may comprise minimal or no curvature. Minimal curvature may comprise configurations where the apex of the curvature of the surface profile deviates from a line (not shown) extending between edges of the handle 104 by no more than a centimeter (or a different threshold deviation, such as 0.5 cm or another value). In some embodiments, the surface profile of the rigid section 106 and the actuatable section 108 may be curved. In other words, the surface profiles of both sections may, from a side view (see FIG. 5) be curved relative to the door (not shown) or, in some embodiments, relative to the housing plate(s) 110. Other surface profile configurations for the handle 104 and/or components thereof are within the scope of the present disclosure, such as a surface profile with one or more planar and one or more curved sections (which may have different characteristics and/or orientations). The housing plate(s) 110 may be at least partially planar or curved relative to the handle 104 and/or a door (not shown) to which the door handle assembly 100 is attached.

In some embodiments, the actuatable section 108 and the rigid section 106 feature a continuous gap 128 between the actuatable section 108 and the rigid section 106 (see also FIG. 4). The continuous gap 128 may comprise one or more linear segments, one or more curved segments, or a combination of linear and curved segments. The linear and curved segments may form a linear or curved shape, respectively, in a two-dimensional viewing plane (e.g., a viewing plane orthogonal to the first direction, represented by FIG. 4). FIG. 4 shows an embodiment in which the continuous gap 128 includes linear segments 404 and a curved segment 406. In the example of FIG. 4, the continuous gap 128 has terminal ends 408 that face different directions relative to each other in the aforementioned two-dimensional viewing plane (though in some embodiments they may face the same direction).

The continuous gap 128 may have any suitable width (in the aforementioned two-dimensional viewing plane), and the width may be constant or varying throughout the continuous gap 128. For instance, the width of the continuous gap 128 may be less than about 1 cm, though other continuous gap widths are within the scope of the present disclosure (e.g., 0.1 cm, 0.5 cm, 1.5 cm, 2 cm, 2.5 cm, 3 cm, or any width greater than, less than, or between of any of the foregoing values).

In the example of FIG. 1, the housing plate(s) 110, the actuatable section 108, and/or the rigid section 106 may define an opening 130 that faces a second direction 122. The opening 130 may be at least partially defined by the offset in the first direction 120 between the housing plate(s) 110 and the actuatable section 108 and/or the rigid section 106, as discussed above. The second direction 122 may be angularly offset from (or traverse to) the first direction 120. In the example of FIG. 1, the second direction 122 is orthogonal to the first direction 120. For the purposes of at least some of the disclosed embodiments, the term “transverse” is used to describe elements, lines, directions, axes, etc. that are not parallel with each other.

The opening 130 may be regarded as an opening to the gripping space 112. As noted above, the gripping space 112 may be divided (conceptually or physically) into multiple gripping spaces, such as a first gripping space 112A defined by the actuatable section 108 and its offset relative to the housing plate(s) 110 and a second gripping space 112B by the rigid section 106 and its offset relative to the housing plate(s) 110.

FIG. 1 depicts an example first extension member 114 that is operatively connected to the actuatable section 108. For instance, the first extension member 114 may be integrally formed with or fixedly connected to the actuatable section 108 such that movement of the actuatable section 108 causes movement of the first extension member 114. As shown in FIG. 1, the first extension member may extend in a third direction 124 that is transverse to the second direction 122. In some instances, the third direction 124 is parallel to the first direction 120. In some implementations, the first extension member 114 contributes to the definition of the gripping space(s) 112.

FIG. 1 also depicts an example second extension member 116 that extends from the first extension member 114 in a fourth direction 126. The fourth direction 126 may be transverse to the third direction 124 and in some instances may be parallel to the second direction 122. In some implementations, the second extension member 116 contributes to definition of the gripping space(s) 112.

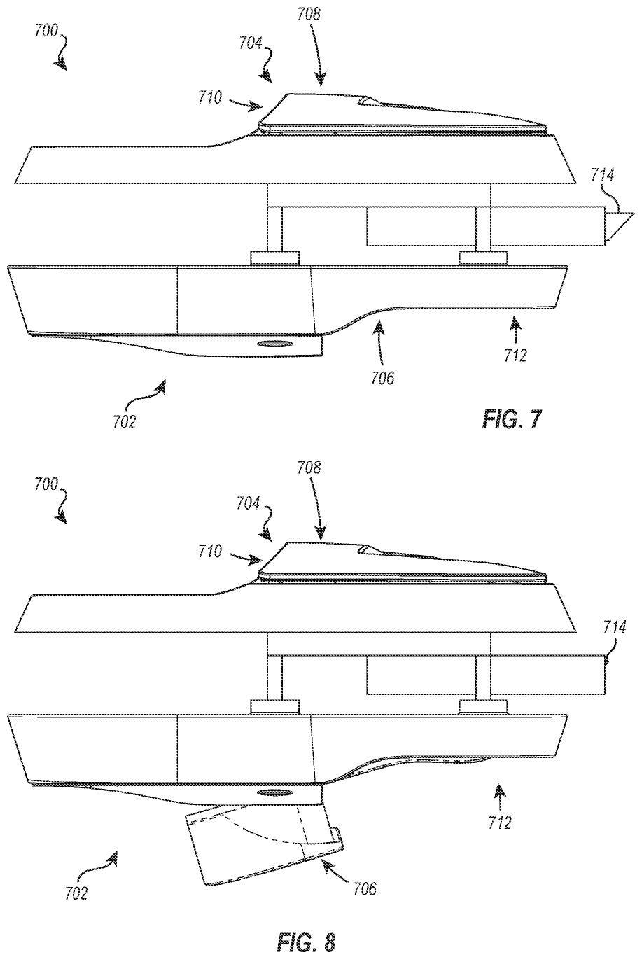

The second extension member 116 may be operatively connected to the first extension member 114 such that movement of the first extension member 114 causes movement of the second extension member 116. As shown in FIG. 1, the second extension member 116 may be operatively connected to a pivot 118 such that the actuatable section 108, the first extension member 114, and the second extension member 116 are configured to rotate about the pivot 118. Furthermore, the second extension member 116 may be operatively connected with the latch 714 (e.g., via a latch actuator 604, as depicted in FIG. 6), such that rotation of the actuatable section 108, the first extension member 114, and/or the second extension member 116 (and/or the latch actuator 604) about the pivot 118 causes actuation of the latch 714 into latched or unlatched configurations to allow for opening or closing of a door (not shown) (FIG. 7 depicts the latch 714 in a latched configuration, and FIG. 8 depicts the latch 714 in an unlatched configuration).

In some embodiments, a latching assembly 132 may comprise components of the door handle assembly 100 that facilitate actuation of the latch 714, such as the actuatable section 108, the rigid section 106, the first extension member 114, the second extension member 116, the pivot 118, and/or the latch actuator 604. At least some components of the latching assembly 132 may rotate (or otherwise move) relative to the rigid section 106.

In some implementations, as shown in FIG. 1, the second extension member 116 may be coplanar, or substantially coplanar, with the housing plate(s) 110. In other words, when the actuatable section 108 is in the latched position, the second extension member 116 may be flush with or follow the surface profile of the housing plate(s) 110. However, in some embodiments, at least part of the user-facing surface of the second extension member 116 may be offset along the first direction 120 relative to the housing plate(s) 110.

As noted above, in some embodiments, the first direction 120 and the third direction 124 may be parallel to one another. In some embodiments, the second direction 122 and the fourth direction 126 may be parallel to one another. In some instances, the second direction 122 is opposite a direction of an insertion direction of user digits (not shown) for operating the door handle assembly 100. In other words, the second direction 122 may be opposite the direction a user would insert their fingers to operate the door handle assembly 100.

In some instances, as shown in FIG. 1, the actuatable section 108 may comprise a gripping hole 134, which may advantageously enable users to utilize additional gripping techniques and/or hand configurations to manipulate the actuatable section 108 to cause actuation thereof between latched and unlatched positions. The gripping hole 134 may comprise any suitable shape or size.

FIG. 2 illustrates a front perspective view of the example door handle assembly 100 in an unlatched configuration. In FIG. 2, the actuatable section 108 is rotated about the pivot 118 (relative to the positioning shown in FIG. 1) and is displaced relative to the rigid section 106. Additionally, FIG. 2 also depicts the first extension member 114 and the second extension member 116 rotated about the pivot 118 and displaced relative to the first extension member 114. As noted above, the actuation of the actuatable section 108, the first extension member 114, and/or the second extension member 116 about the pivot 118 can cause actuation of the latch 714, which can cause selective disengagement of a door to which the door handle assembly 100 is attached from a corresponding door frame.

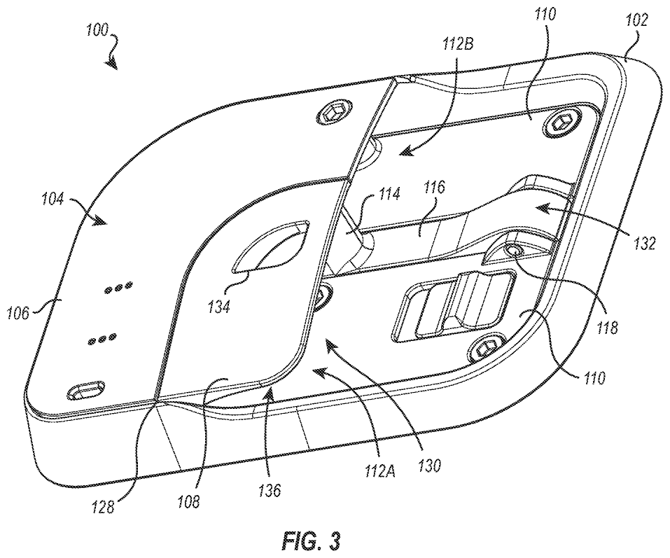

FIG. 3 illustrates another perspective view of the example door handle assembly 100 in the latched configuration. FIG. 3 illustrates that, in some embodiments, the gripping space 112 may feature a second opening 136 in a fifth direction 127 that is angularly offset from the second direction 122 associated with the opening 130 discussed above. Such a configuration can advantageously allow for the insertion of user digits (not shown) from multiple directions. The opening 130 and the second opening 136 may be regarded as a single opening that opens in multiple directions. In some embodiments, the opening 130 and the second opening 136 may be separated by a physical component of the door handle assembly 100.

FIG. 4 illustrates a front facing view of the example door handle assembly 100 in the latched configuration, which depicts the continuous gap 128 formed between the actuatable section 108 and the rigid section 106 of the handle 104. FIG. 4 also depicts the proximate placement of the actuatable section 108 and the rigid section 106, as discussed above.

FIG. 5 illustrates a side view of the example door handle assembly 100 in the latched configuration. FIG. 5 shows the first extension member 114 and depicts the aligned surface profiles of the actuatable section 108 and the rigid section 106 of the handle 104 when in the latched position. FIG. 5 depicts a curved surface profile of the rigid section 106 and the actuatable section 108. A planar surface profile is easily contemplated by flattening both the rigid section 106 and the actuatable section 108. In some embodiments, the surface profile of the rigid section 106 and actuatable section 108 may be partially planar and/or partially curved.

FIG. 6 illustrates a rear facing view of the example door handle assembly 100 in the latched configuration. The door handle assembly 100 of FIG. 6 includes a latch actuator 604, which allows for operation of a latch 714 (see FIGS. 7 and 8). As noted above, the pivot 118 is operatively connected to the latch actuator 604 such that rotation of components of the latching assembly 132 about the pivot 118 causes actuation of the latch actuator 604 (which in turn causes actuation of the latch 714).

FIG. 7 illustrates a top view of an interior component 702 and an exterior component 704 of a door handle assembly 700 in a latched configuration. The interior component 702 of the door handle assembly 700 may include aspects of and/or generally correspond to the door handle assembly 100 discussed hereinabove. In some implementations, the interior component 702 is located on the interior of an RV door (not shown) and the exterior component 704 is located on the exterior of the RV door (not shown). One will appreciate that the interior component 702 and/or the exterior component 704 may include one or more features that extend into and/or through the body of the RV door.

FIG. 7 depicts an example in which the interior component 702 and the exterior component 704 are operatively connected to a latch 714 such that actuation of aspects of one or both components 702, 704 causes actuation of the latch 714. For instance, actuation of an interior latching assembly 706 of the interior component 702 may cause actuation of the latch 714, and actuation of an exterior latching assembly 708 of the exterior component 704 may cause actuation of the latch 714. The exterior latching assembly 708 may be configured to rotate about an exterior pivot 710 that is offset from an interior pivot 712 associated with the interior latching assembly 706. FIG. 8 illustrates a top view of the interior component 702 and the exterior component 704 of a door handle assembly 700 in an unlatched configuration (e.g., with the interior latching assembly 706 rotated about the interior pivot 712).

Although at least some examples discussed herein have focused, in at least some respects, on mechanical connections between components of a door handle assembly and a latch 714, other types of connections are within the scope of the present disclosure. For instance, the latch 714 could be embedded within a door (not shown) and configured to be actuated by an actuator that is separate from the interior component 702 or the exterior component 704 in response to a wired or wireless communication triggered by the interior component 702 or the exterior component.

### CONCLUSION

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

What is claimed is:

1. A door handle assembly, comprising:
a housing; and
a handle connected to the housing, the handle comprising:
a rigid section that is configured to maintain a fixed position relative to the housing during operation of the door handle assembly; and
an actuatable section configured for actuation between a latched position and an unlatched position during operation of the door handle assembly, wherein the actuatable section is arranged adjacent to the rigid section when the actuatable section is in the latched position, wherein the actuatable section follows a surface profile of the rigid section when the actuatable section is in the latched position.

2. The door handle assembly of claim 1, wherein the surface profile comprises an at least partially planar profile or an at least partially curved profile.

3. The door handle assembly of claim 1, wherein, when in the latched position, the actuatable section and the rigid section form a continuous surface profile except for a continuous gap defined between the actuatable section and the rigid section.

4. The door handle assembly of claim 3, wherein, when in the latched position, the continuous gap comprises a gap width of no more than 1 centimeter.

5. The door handle assembly of claim 3, wherein, when in the latched position, the continuous gap comprises a gap length of greater than 1 centimeter.

6. The door handle assembly of claim 1, wherein, when in the latched position, a shortest distance between the actuatable section and the rigid section is no more than 1 centimeter.

7. The door handle assembly of claim 1, wherein, when in the latched position, a distance between the actuatable section and the rigid section along a continuous segment of an edge of the actuatable section is no more than 1 centimeter.

8. The door handle assembly of claim 7, wherein the continuous segment of the edge of the actuatable section is longer than 1 centimeter.

9. The door handle assembly of claim 7, the continuous segment comprises at least one straight segment and at least one curved segment.

10. The door handle assembly of claim 1, wherein the actuatable section and the housing define a gripping space to allow for user digits.

11. A door handle assembly, comprising:
a housing comprising one or more housing plates; and
a handle connected to the housing, the handle comprising:
a rigid section that is configured to maintain a fixed position relative to the housing during operation of the door handle assembly, wherein the rigid section is offset from the one or more housing plates in a first direction; and
an actuatable section configured for actuation between a latched position and an unlatched position during operation of the door handle assembly, wherein the actuatable section is offset from the one or more housing plates in the first direction when the actuatable section is in the latched position,
wherein, when the actuatable section is in the latched position:
the handle and the one or more housing plates define a contiguous gripping space,
a region between the rigid section and at least one of the one or more housing plates defines a first portion of the contiguous gripping space, and
a region between the actuatable section and the at least one of the one or more housing plates defines a second portion of the contiguous gripping space.

12. The door handle assembly of claim 11, wherein the contiguous gripping space is further defined by an extension member associated with the actuatable section.

13. The door handle assembly of claim 11, wherein the contiguous gripping space comprises at least two openings in at least two directions.

14. The door handle assembly of claim 11, wherein the first portion of the contiguous gripping space and the second portion of the contiguous gripping space are at least partially separated by an extension member associated with the actuatable section.

15. A door handle assembly, comprising:
a housing comprising one or more housing plates; and
a latching assembly comprising:
an actuatable section configured for actuation between a latched position and an unlatched position during operation of the door handle assembly, wherein the actuatable section is offset from the one or more housing plates in a first direction when the actuatable section is in the latched position,
wherein, when the actuatable section is in the latched position, the actuatable section and the one or more housing plates define an opening that faces at least a second direction, wherein the second direction is transverse to the first direction;
a first extension member operatively connected to the actuatable section that extends transverse to the second direction in a third direction; and
a second extension member that extends from the first extension member in a fourth direction that is transverse to the third direction, wherein the second extension member is operatively connected to a pivot, and wherein rotation of the latching assembly about the pivot is configured to cause actuation of a latch.

16. The door handle assembly of claim 15, wherein the first direction is parallel to the third direction.

17. The door handle assembly of claim 15, wherein the second direction is parallel to the fourth direction.

18. The door handle assembly of claim 15, wherein the second direction is opposite a direction of an insertion direction of user digits for operating the latching assembly.

19. The door handle assembly of claim 15, wherein the door handle assembly further comprises an exterior latching assembly operatively connectable to the latch, and wherein the exterior latching assembly is configured to rotate about an exterior pivot that is offset from the pivot.

20. The door handle assembly of claim 15, wherein a portion of the second extension member is substantially coplanar with the one or more housing plates.
